(19) United States
(12) Patent Application Publication
(10) Pub. No.: US 2023/0131210 A1
(43) Pub. Date: Apr. 27, 2023

(54) HOOK GUARD

(71) Applicant: Pure Fishing, Inc., Spirit Lake, IA (US)

(72) Inventor: Cameron Ivie, Irmo, SC (US)

(21) Appl. No.: 18/048,479

(22) Filed: Oct. 21, 2022

Related U.S. Application Data
(60) Provisional application No. 63/263,029, filed on Oct. 26, 2021.

(51) Int. Cl. A01K 87/00

(52) U.S. Cl. CPC A01K 87/007

(57) ABSTRACT

A hook guard is provided that is attachable with or integrally formed with a fishing rod. The hook guard includes at least one opening through which a fishing hook may be received and to which the fishing hook may be coupled. The hook guard provides a secure and safe location on a fishing rod where the fishing hook cannot snag or otherwise damage objects or people.

### CROSS-REFERENCE TO RELATED APPLICATION

This application claims the benefit of the filing date of U.S. Provisional Application No. 63/263,029 filed Oct. 26, 2021, entitled HOOK GUARD, the entire contents of which are incorporated herein by reference.

### FIELD OF INVENTION

The present invention is generally directed to fishing rods. In particular, the invention relates to a hook guard for a fishing rod used to stow a hook safely and securely when the hook is not in use.

### BACKGROUND OF THE INVENTION

In fishing, hooks are attached to a fishing rod and line and are subsequently used to secure a catch. To ensure the hook's effectiveness, hooks are typically quite sharp. Thus, if hooks are not safely and securely stored, they can cause damage to various objects that a hook could contact, including anglers themselves. As such, it is well known to equip a fishing rod with a hook guard. Hook guards may protect the angler from the sharp end of a hook by securing the hook to the hook guard when the hook is not in use. Hook guards are also commonly used in association with fishing rods for children.

Existing structures for holding a hook on a fishing rod employ wire forms or simple holes that can leave the point of the hook exposed where it can catch on people or objects. Moreover, conventional hook guards do not allow for multiple orientations. Therefore an angler may not be able to customize the placement of the hook guard to best suit their equipment.

Thus, there is a need for an improved hook guard that can protect the point of the hook while also providing multiple ways to attach the hook guard to a fishing rod and multiple ways to attach one or more hooks to the hook guard.

### SUMMARY OF THE INVENTION

The present invention is directed towards a hook guard for quickly and safely securing one or more fishing hooks while the hooks are not in use. A fishing equipment assembly generally includes a handle, a fishing rod attached to and extending from a first end of the handle, and a hook guard attached to a portion of the fishing equipment assembly. The hook guard may comprise a curved surface comprising a front opening positioned on a first side of the curved surface, wherein the front opening is configured to receive a hook attached to the fishing rod. The hook guard may further comprise a cavity formed within an interior of the curved surface, wherein the cavity is configured to house at least a portion of the hook.

The hook guard may be formed monolithically with the handle. Alternatively, the hook guard may be a separate structure configured to be attached to fishing equipment. The hook guard may be permanently or temporarily attached to the fishing equipment.

The hook guard may have an approximately cylindrical or conical shape. As such, a first end of the hook guard may be larger than a second end of the hook guard. The first end of the hook guard may be open, thereby forming a front opening in the hook guard. The body of the hook guard may further comprise one or more openings. The body may comprise a first side opening. The body may further comprise a second side opening opposite the first side opening.

An angler may use the hook guard to secure one or more hooks in the hook guard. In one configuration, a first hook may be inserted through the front opening. In another configuration, the first hook may be inserted through the first side opening or second side opening. In yet another embodiment, the first hook may be inserted through the front opening or the second opening. The angler may further secure a second hook according to any of the above configurations.

The foregoing and other features of the present invention will be apparent from the detailed description that follows.

### BRIEF DESCRIPTION OF THE DRAWINGS

In the accompanying drawings, which form a part of the specification and are to be read in conjunction therewith in which like reference numerals are used to indicate like or similar parts in the various views:

FIG. 1 is side plan view of a fishing rod handle including a hook guard in accordance with a first embodiment of the present invention;

FIG. 2 is a partial perspective view of the fishing rod of FIG. 1; and

FIG. 3 is a cross-sectional view of the fishing rod handle of FIG. 1.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE DRAWINGS

The invention will now be described with reference to the drawing figures, in which like reference numerals refer to like parts throughout. For purposes of clarity in illustrating the characteristics of the present invention, proportional relationships of the elements have not necessarily been maintained in the drawing figures. The embodiments are intended to described aspects of the invention in sufficient detail to enable those skilled in the art to practice the invention. Other embodiments can be utilized, and changes can be made without departing from the scope of the present invention. The present invention is defined by the appended claims and the description is, therefore, not to be taken in a limiting sense and shall not limit the scope of equivalents to which such claims are entitled.

The present invention is generally directed to a hook guard attached to fishing equipment, such as a fishing rod. The hook guard is configured to stow one or more fishing hooks safely and securely when the hook(s) are not in use. The present invention may utilize any currently known fishing rod or fishing rods that have yet to be designed, manufactured, or may otherwise become available in the future. The present invention may further be used with a variety of models of hooks and may be adapted for use with any currently known hooks or hooks that have yet to be manufactured, discovered, or otherwise become available.

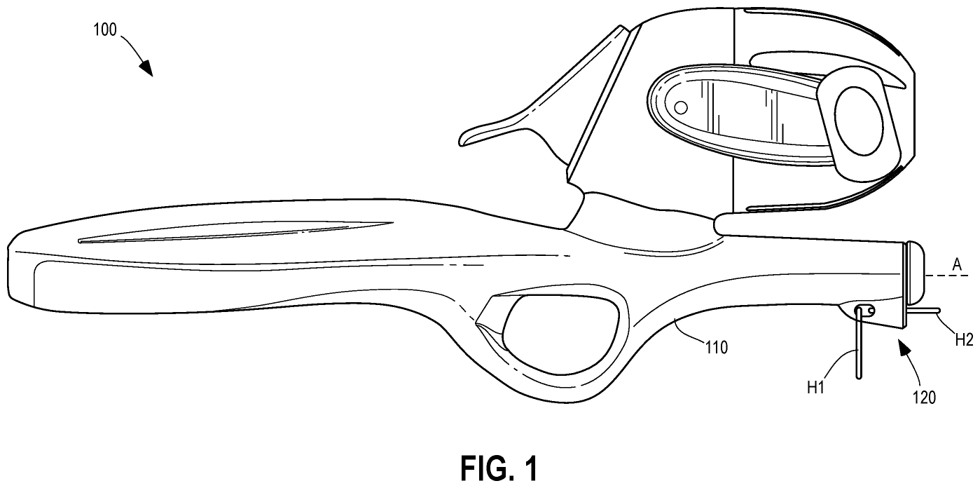

FIGS. 1-3 illustrate various views of a hook guard. In a first embodiment, as demonstrated in FIG. 1, a fishing rod assembly 100 is shown. The assembly 100 includes a handle 110 and a hook guard 120 attached to the handle 110. The assembly 100 may include one or more parts not shown, such as a rod attached to the handle 110 along a latitudinal axis A.

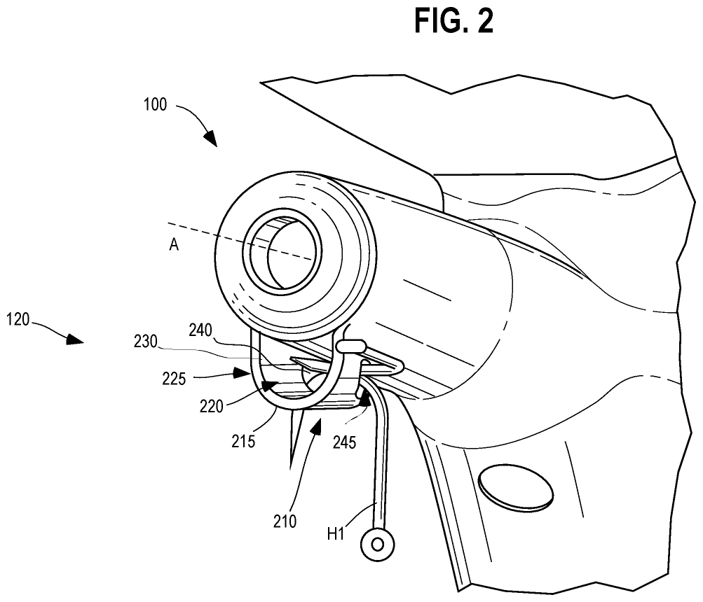

As illustrated best in FIG. 2, the hook guard 120 is comprised of a body 210. The body 210 may comprise a first surface 215. The first surface 215 can be a curved surface that extends upwardly toward the assembly 100 in a U-like shape. A cavity 220 may be formed between the first surface 215 and a portion of the assembly 100. The first surface 215 may comprise one or more openings such that one or more fishing hooks can be inserted through the one or more openings into the cavity 220.

In one embodiment, a first end 225 of the hook guard 120 is open, thereby forming a front opening 230 in the hook guard 120. Alternatively, in another embodiment, the first end 225 may be closed. For example, the first end 225 may be comprised of a solid surface. In an embodiment, the hook guard 120 comprises a first side opening 235 positioned on a first side of the first surface 215. In one embodiment, the hook guard 120 further comprises a second side opening 240 positioned on a second side of the first surface 215. The first side opening 235 and the second side opening 240 may be positioned directly opposite each other on opposing sides of the first surface 215.

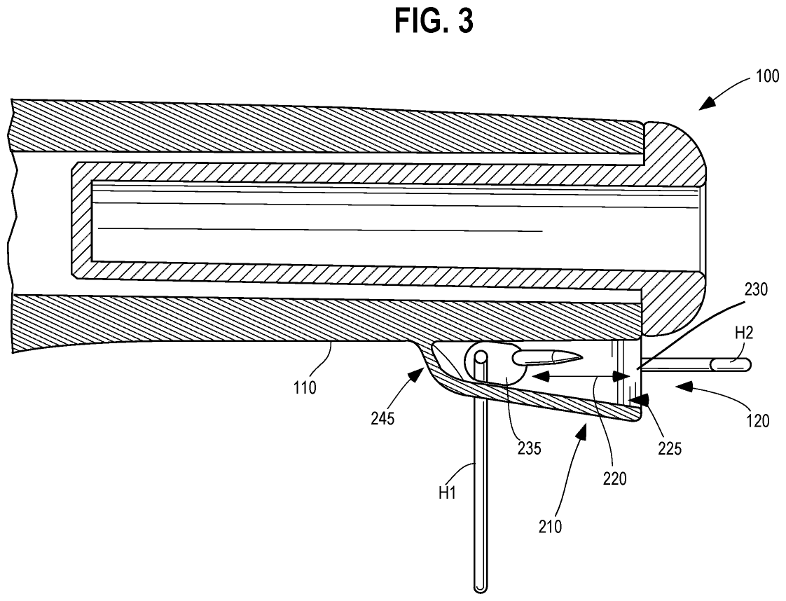

As shown best in FIG. 3, the hook guard 120 may have an approximately conical shape. Therefore, the first end 225 may have a first cross-sectional area, and a second end 245 opposite the first end 225 may have a second cross-sectional area, wherein the second cross-sectional area is less than the first cross-sectional area. In some embodiments, the hook guard 120 can be made integral with the handle 110. For example, the body 210 can be formed monolithically with the handle 110 in a single manufacturing process. Various manufacturing processes such as injection molding and the like known in the art are contemplated for constructing the assembly 100. Further still, in some embodiments, the hook guard 120 can be manufactured separate from the handle 110 and coupled thereto via various means, including various bonding methods and/or the use of mechanical fasteners as known in the art. The hook guard 120 may be permanently attached to the handle 110 or may be attached such that it can be removed and reattached.

As shown, the hook guard 120 may be positioned on an underside of the handle 110. However, it is to be understood that the hook guard 120 may be positioned on the handle 110 in various locations and orientations not shown. For example, in some embodiments, the hook guard 120 may be positioned on a top portion of the handle assembly, an a side portion of the handle assembly, or on the rod of the fishing equipment assembly. In some embodiments, the hook guard 120 may come attached to the handle 110. As discussed above, even in embodiments where the hook guard 120 is attached to the handle 110, the hook guard 120 may be configured to be movable. In other embodiments, the hook guard 120 may not initially be attached to the handle 110. Thus, by providing a hook guard 120 that may be repositioned or attached by an angler, the angler may position the hook guard 120 on fishing equipment at a location to best suit their needs. Moreover, by having a detachable hook guard 120, it may be easier to replace the hook guard 120 and perform maintenance on the fishing equipment.

With respect to the above embodiments, the hook guard 120 is configured to secure one or more fishing hooks. In one embodiment (as shown in FIGS. 1-3) the hook guard 120 is configured to secure a first fishing hook H1, and a second fishing hook H2. The first fishing hook H1 and the second fishing hook H2 may be positioned in a variety of configurations. For example, as shown, in a first configuration, the first fishing hook H1 may pass through each of the first side opening 235 and the second side opening 240, such that a portion of the first hook H1 resides in the cavity 220. By inserting the hook H1 through both the first side opening 235 and the second side opening 240, the weight and bend of the first hook H1 may pre-dispose the first hook H1 to remain in the hook guard 120 even under reduced tension imparted by a fishing line (not shown) attached to both the first hook H1 and the fishing rod assembly 100 against the hook guard 120.

In one embodiment, the second hook H2 is secured in a second configuration. In the second configuration, the second hook H2 may pass through at least one of the first side opening 240 and the second side opening 250. An end of the second fishing hook H2 may be contained within the cavity 220.

In another embodiment, the second hook H2 can be inserted through the front opening 230 to enter into the cavity 220. An end of the second hook H2 may further be inserted through the first side opening 235 or the second side opening 240.

In another embodiment, the hook guard 120 is configured to secure one hook. In embodiments, where the hook guard 120 secures a single hook, the single hook may be in any of the above configurations. For example, a single hook may be inserted into the hook guard 120 in a similar position to the first hook H1 or inserted into the hook guard 120 in a similar position to the second hook H2.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A fishing equipment assembly, comprising:
a handle;
a fishing rod attached to and extending from a first end of the handle; and
a hook guard attached to a portion of the fishing equipment assembly, the hook guard including:
a first surface including a first side opening positioned on a first side of the first surface, wherein the first side opening is configured to receive a first hook attached to the fishing rod; and
a cavity formed within an interior of the first surface configured to house at least a portion of the first hook.

2. The fishing equipment assembly of claim 1, wherein the hook guard is configured to receive the first hook in a first orientation where the first hook passes through the first side opening and an end of the first hook is contained within the cavity.

3. The fishing equipment assembly of claim 1, wherein the hook guard is formed monolithically with at least a portion of the fishing equipment assembly.

4. The fishing equipment assembly of claim 1, wherein the hook guard includes a second surface connected to the first surface; and
wherein the second surface is configured to be attached to the fishing equipment assembly.

5. The fishing equipment assembly of claim 4, wherein the second surface is permanently attached to the fishing equipment assembly.

6. The fishing equipment assembly of claim 4, wherein the second surface is temporarily attached to the fishing equipment assembly.

7. The fishing equipment assembly of claim 1, wherein the first surface includes a second side opening positioned on a second side of the first surface; and
wherein the second side is opposite the first side.

8. The fishing equipment assembly of claim 7, wherein the first surface includes a front opening positioned at a first end of the cavity.

9. The fishing equipment assembly of claim 8, wherein the hook guard is configured to receive the first hook in a second orientation; and
wherein in the second orientation, the first hook passes through both the front opening and the second side opening.

10. The fishing equipment assembly of claim 9, wherein the hook guard is configured to receive a second hook in a third orientation; and
wherein in the third orientation, the second hook passes through the front opening and at least one of the front side opening and the second side opening.

11. A hook guard, comprising;
a body including:
a first surface including a first opening configured to receive a hook;
a second surface configured to be attached to fishing equipment; and
wherein a cavity is formed between the first surface and the second surface.

12. The hook guard of claim 11, wherein the body has an approximately conical shape.

13. The hook guard of claim 11, wherein:
the body has a first end having a first cross-sectional area;
the body has a second end opposite the first end having a second cross-sectional area; and
the first cross-sectional area is greater than the second cross-sectional area.

14. The hook guard of claim 13, wherein the first end is open.

15. The hook guard of claim 13, wherein the first end is closed.

16. The hook guard of claim 13, wherein the second end is open.

17. The hook guard of claim 13, wherein the second end is closed.

18. The hook guard of claim 11, wherein the first opening is positioned on a first side of the first surface.

19. The hook guard of claim 18, wherein the body includes a second opening positioned on a second side of the first surface opposite the first opening.

20. The hook guard of claim 19, wherein the body includes a first end and a second opposite the first end; and
each of the first opening and the second opening are positioned proximal to the second end of the body.
